(19) United States
(12) Patent Application Publication
(10) Pub. No.: US 2006/0107213 A1
(43) Pub. Date: May 18, 2006

(54) Intelligent multimodal navigation techniques using motion of a mobile device sensed by a motion sensing device associated with the mobile device

(76) Inventors: Sunil Kumar, San Diego, CA (US); Subramanya R. Uppala, San Diego, CA (US); Dipanshu Sharma, San Diego, CA (US); Chandra Kholia, San Diego, CA (US); Fernando Corona, San Diego, CA (US)

Correspondence Address: FISH & RICHARDSON, PC, P.O. BOX 1022, MINNEAPOLIS, MN, 55440-1022, US

(21) Appl. No.: 11/206,652

(22) Filed: Aug. 17, 2005

Related U.S. Application Data
(60) Provisional application No. 60/602,368, filed on Aug. 17, 2004.

(51) Int. Cl. G06F 3/00; G06K 9/20

(52) U.S. Cl. 715/700; 382/312

(57) ABSTRACT

Motion is used as an input to a program running on a mobile device. The mobile device may require input also from alphanumeric or text input device. The motion can be used for items such as selection from a list, or navigation on the map. The motion can be sensed on image processing the output of the camera, or can be directly determine using an accelerometer. Existing programs can be explicitly modified, in which case the program accepts the motion directly. Alternatively, the modification can be implicit—where the motion is converted to a signal that the program can accept, without modification.

### PRIORITY

Under 35 U.S.C. §119(e)(1), this application claims the benefit of prior U.S. provisional application 60/602,368, filed Aug. 17, 2004.

### CROSS-REFERENCE TO RELATED APPLICATIONS

This application is related to co-pending U.S. patent application Ser. No. 10/040,525, entitled INFORMATION RETRIEVAL SYSTEM INCLUDING VOICE BROWSER AND DATA CONVERSION SERVER, and to co-pending U.S. patent application Ser. No. 10/336,218, entitled DATA CONVERSION SERVER FOR VOICE BROWSING SYSTEM, and to co-pending United States Provisional patent application Ser. No. 10/349,345, entitled MULTI-MODAL INFORMATION DELIVERY SYSTEM each of which are each incorporated herein by reference in their entirety.

### FIELD

The present disclosure describes techniques of using Motion as an interactive mode of accessing and/or entering information in a thin client, e.g. a mobile telephone or other miniaturized device. In one aspect, the motion adds another mode to the existing multimodal applications which currently use speech and text (keypad) as the available modes for interaction. The motion interaction mode can be used to allow the user to navigate through the application without using traditional keypad based navigation methods.

### BACKGROUND

Certain clients are often miniaturized, in order to facilitate them being carried with the user. One example of such clients is a mobile telephone. While the computing portion and the display can be miniaturized, it is often difficult to enter information into such clients. Some clients include numeric keyboard and/or miniaturized alphanumeric keyboards.

### SUMMARY

An aspect describes using motion as an input to a program running in a mobile client.

An embodiment describes sensing motion of the mobile client, and using the sensed motion as input to a program running on said mobile client to signal an input to the program, and to use said input to change some running aspect of the program. Different embodiments describe different programs, and different ways of integrating with those programs.

### BRIEF DESCRIPTION OF DRAWINGS

FIG. 1A illustrates an embodiment of a portable client which is implemented as a mobile phone.

FIG. 1B illustrates the high level architecture of the motion subsystem, and the five different layers of motion interface that are provided thereby.

FIG. 2 shows an example of a user interface for a mobile browser based on a WML visual source described in this application.

FIG. 3A show shows an exemplary image of the map that is displayed initially on the device using MotionImageViewer object.

FIG. 3B shows an exemplary view of the map when the application upon receiving the event would scroll the map in the downward direction by x pixels.

FIG. 3C shows an exemplary view of the map when the application upon receiving the event would move the map in the upward direction by x pixels.

FIG. 3D shows an exemplary view of the amp when the application upon receiving the event would move the map in the left direction by x pixels.

FIG. 3E shows an exemplary view of the amp when the application upon receiving the event would move the map in the right direction by x pixels.

FIG. 3F shows an example where the map is moved down by one page and the user is prompted with following message “Map is scrolling down by one page.”

FIG. 3G shows an exemplary view of the amp when the application upon receiving the event would move the map in the upwards direction by a whole page.

FIG. 3H shows an example where the map has moved left by one page and the user is prompted with following message “Map is scrolling left by one page.”

FIG. 3I shows an example where the map has moved right by one page and the user is prompted with following message “Map is scrolling right by one page.”

FIG. 3J shows an example where the map has moved in the North East direction.

FIG. 4 describes the architecture of an application using motion.

FIG. 5 illustrates an example for the event call flow.

FIG. 6 illustrates an example for the stopping event generation.

### DETAILED DESCRIPTION

The present application recognizes that motion of the miniaturized client may be harnessed as one way of communicating information. The motion provides another way of representing information in addition to or in place of other modes such as text or speech.

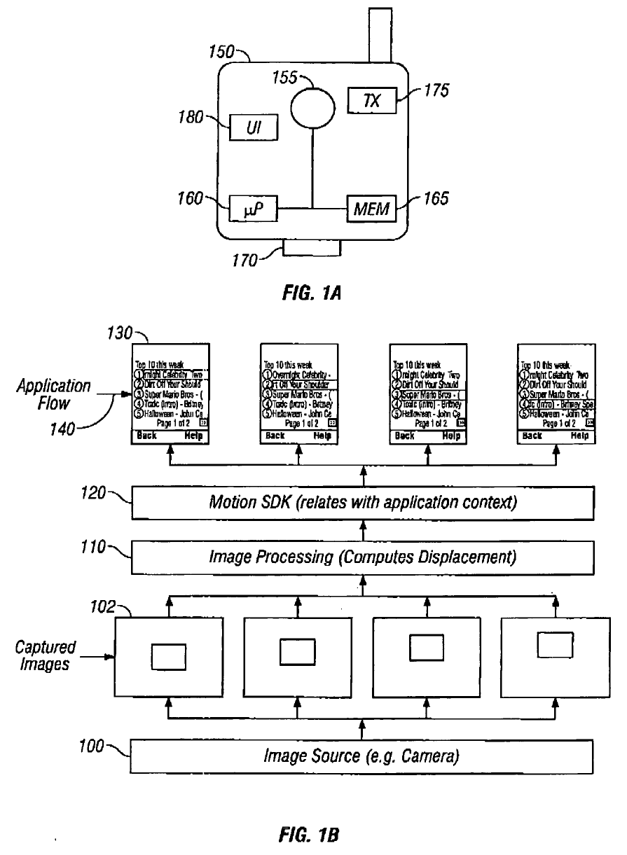

FIG. 1A illustrates an embodiment of a portable client, here a mobile phone 150. The client includes a motion sensing part 155. The motion sensing part 155 may be for example a camera, or an accelerometer. Other parts which may sense motion can alternatively be used, and the patentee intends the motion sensing part to encompass all different ways of sensing motion. The client also includes a processor 160, and a memory 165 which stores information to be executed by the processor 160 and also information which is uploaded and download. The processor 160 can be any device which can execute instructions, or operate according to receive inputs to determine parameters based on the received inputs. The client may also include a data port 170 which enables programming and other connections to the memory and processor. In the embodiment, the client is a cellular handset, and uses a cellular transceiver 175. The client may also include a user interface 180, which may include conventional ways of entering information and may include a display, a numeric for alphanumeric keypad, and/or a speech recognition module.

The motion mode according to the present system operates by capturing the movement of the motion sensing part and relating that movement with the correct application context. The application resident in memory 165 may provide the necessary parameters required by a Motion sensor, here a software development kit, detects the motion and imports it into the application. The application can use a predefined motion UI templates or APIs exported by the Motion SDK for providing these parameters.

The motion as a mode of input/output is very different than gesture recognition. In gesture recognition, a camera plugged into a device is used to interpret movements or gestures in the area of the camera.

The motion SDK provides a reference mechanism. For example, a traditional key/mouse based system highlights the selected option with a mouse hovering over the selected option. The Motion SDK of the present system may provide an analogous reference. For example, options are highlighted as the user moves the device. A mark (e.g. a red circle in the embodiments) hovers around the point of reference so the user can track their current location.

The motion mode enables a user to provide input by moving the device 150. The motion can be computed either by using images taken by the camera using an image processing system, or alternatively by sensing motion directly using the Accelerometer or any other motion sensing device. The movement can be used as input for different applications including, but not limited to, Map Navigation, Scrolling, Games etc. The motion and the application context are intelligently combined, to allow the applications using motion to act on motion actions. A few examples include:
1. Motion as mouse (navigating menus): Motion in upwards or downwards direction cause the application to select an option from a menu. In this case, if an application displays a list of options on the screen with first option selected by default, the motion in the downwards direction highlights the second option. Here the upwards/downward motion is used as scroll keys.
2. Motion as simulating games: in games, the motion can be taken as input in simulating the trajectory of the Golf swing, baseball etc.
3. Motion for navigating maps: The motion mode could easily be applied to map navigation where the user can move the phone instead of using the scroll keys.

In addition, the application can relate the effect of motion with other various multi-modal components provided by V-Enable such as speech. For example while the user is navigating a map using the motion mode, speech could be added which prompts the name of the place on the map as user navigates through the map. Similarly while a user is scrolling through a list of options to choose from, the speech could be added which prompts the currently highlighted option.

This disclosure discusses the methods by which the movement captured through a camera could be applied to the application. The Motion APIs (part of veCLIENT, see our earlier patent applications) allow an application developer to register the type of service they wish to receive such as scrolling, mouse (in the earlier list of examples, scrolling and mouse were used to explain the same example), map navigation etc. Based on the request the Motion API would internally relate the movement with the application and generate appropriate events to notify to the user.

This disclosure discusses the event mechanism which allows an application to react to any motion caused as the user moves the device. This patent also discusses methods which scale the displacement caused due to motion within the current context of the application as described previously. For example, 5 cm of camera movement may only result in 1 cm of movement on the application.

Techniques which relate motion with existing modes such as speech and text are also disclosed. These methods allow application developers to develop usable application by mixing motion, speech and text.

The embodiment discloses a camera being used as the source of an image, since cameras are already ubiquitous within mobile telephones. However the technique is not restricted only to a camera and can be applied to any other source.

An embodiment detects motion experienced by the mobile equipment and translates it into a corresponding vector expressing displacement and direction. This vector is then used to produce application directed events. Once the displacement is determined, the application can use it in an event-based model. The motion of the mobile provides a specific motion produced by the user of the mobile to provide an input to the current application. For example, the user moves the mobile to the left to avoid an impending obstacle in a game with obstacles.

There are different methods to detect the motion. Examples include:
1. Use of an accelerometer to determine the acceleration experienced by the device and eventually, the velocity and displacement involved.
2. Use of a camera to capture the frames and run them through image processing techniques such as mean shift algorithm, frame differencing, optical flow etc to determine the displacement involved.

Cameras are very common in devices today. Developers have access to the camera APIs and hence can use modules for existing mobiles to produce such application directed events.

The motion recognition can be effected in the following ways. A first way is to process the live feed coming from the camera or other motion source (e.g. accelerometer) and track the movement. The movement is scaled with respect to the display being used. The results are obtained and applied to the application context.

This can be achieved by implementing widely available image processing algorithms. The algorithm allows tracking the camera's movement as the user moves the camera. A mechanism can take the input from point 1 and allow the user to navigate through the application. The application uses the motion through an API interface which coordinates with the image processing software and posts appropriate events to the application.

The API can be provided as the part of a SDK package. The Motion SDK provides a motion event mechanism which is similar to the existing input mechanisms (e.g. scroll keys). The use of SDK allows the user to create applications and associate the menus, and images browsing with the motion.

FIG. 1B illustrates the high level architecture of the motion subsystem, and the five different layers of motion interface that are provided thereby. The software system shown in FIG. 1B may be resident within the memory 165 of the mobile client 150.

The Image Source Interface 100 forms the lowest layer, e.g. the camera interface provided by the underlying system. This layer allows Motion interface to capture images such as 102. Image processing layer 110 takes input as images from the camera interface 100 and computes the displacement from the successive images using a standard image processing algorithm. This layer is only needed if camera is used as the source. In case of an accelerometer, this layer may be removed. The Motion Interface layer 120 takes input from the image processing layer and application layer and generates appropriate events. The motion interface exports appropriate UI interfaces such as 130 which allows an application developer to use motion in variety of different forms. The UI interface provides ready made templates for application developers. The motion interface also exports an event mechanism which notifies the application as the camera moves. The event mechanism allows the application developer to customize their application as per their requirements.

Application: The application layer 140 uses the UI templates provided by the motion interface or use the event mechanism for customize application development.

The following section discusses details about the motion interface, UI templates and the event mechanism.

### Motion Interface

The motion interface gets the displacement from the image processing layer and generates events as the camera moves. List of events may include the following:

MOTION_DOWN

MOTION_UP

MOTION_LEFT

MOTION_RIGHT

MOTION_DOWN_PAGE

MOTION_UP_PAGE

MOTION_LEFT_PAGE

MOTION_RIGHT_PAGE

MOTION_ANY_DIRECTION

MOTION_SELECT

The above events allow the application to determine a direction the user is moving the camera and an amount of movement. The events are subject to the UI screen and dimensions of the objects in that screen. The application provides the information about the UI elements and the events they are interested in. The motion interface provides a mapping between real displacement and virtual displacement. The real displacement is the actual displacement caused when a camera is moved. The virtual displacement is scaled up or down value based on the real displacement. For example, a real displacement could be 20 mm in the upward direction. However, the scaled displacement is movement on the phone—based on the size of the screen, it may be desirable to treat that movement as some other number e.g. 30 mm or may be 10 mm. This scaling is a configurable parameter and may be changed for each device. The motion interface takes dimension of the UI elements of the application and relates them with the virtual displacement and generates events.

For example an application may have 5 elements in a list each of width×(10) pixels. The motion interface gets the real displacement from the image processing layer, converts it into the virtual displacement. If the virtual displacement is more than 10 pixels and less than 20 pixels in downward directions, the motion interface generates MOTION_DOWN event indicating to the application that the cursor has to be moved down by one listing. The same applies if the displacement is in the upward direction which generates MOTION_UP event. MOTION_RIGHT is generated when the motion is in right direction and similarly for MOTION_LEFT. The motion interface also generates page events which allow application to navigate on a page basis. The page displacement is computed based on the size of the display. Assuming the height of the page is P pixels, the motion SDK generates page events whenever the virtual displacement is more than P pixels in a short period of time T.

The event mechanism allows an application to change their behavior as per their requirement. The use of the events will be explained later with an example. The setup of events defined above are the major events, but the other techniques may be used to generate more events as per the application requirement.

Integrating Event Mechanism with the UI Objects

The event mechanism forms the basis of the motion interface. Application developers can use this interface, as well as the event mechanism, to control the flow of the application. The motion interface provides the basis of motion objects which are exported to the developer so they can create Motion based applications using existing templates.

The event mechanism can be used in an analogous way—it can generate existing events corresponding to the UI element layout of the screen and the motion observed. The event mechanism processes the motion objects such as Motion Menu, Motion Image Viewer etc. These objects can either be created separately or motion can be integrated with the existing UI controls present in the system. If a system already has menu control built in which allows traditional mode of navigation using left/right/up/down keys, the motion interface takes the specification of existing menu control as input and integrates motion into it. This allows user to use existing UI controls with motion. The combination of existing UI controls with motion can be explicit or implicit. In the explicit case, the user specifies what existing UI objects should become motion enabled. In the implicit case, all existing UI objects become motion enabled. This is achieved by integrating the motion APIs with the phone software or OS.

Motion with Existing UI Objects—Device Driver Approach

As discussed above, the motion mode is used through new UI objects. However many application development environments already have existing UI objects, such as Menu, List, Image Viewer and others. Typically these objects are accessed through the keypad interface. The motion mode supplements the existing keypad interface and allows a user to use motion instead of using the keypad interface. The keypad interface already exists on all mobile devices. Some UI objects allow application developers to create applications. The motion interface inherits the existing UI objects and adds its event mechanism to it. This can be done by integrating motion APIs with the phone's native software. Motion APIs then get integrated as a motion driver in the phone software/operating system. This allows an application developer to motion based applications while continue using the existing UI templates. In order to enable the existing UI with motion, the application passes the UI object information to the APIs provided by the motion interface. The information can be provided through the API provided by the motion interface. Using motion APIs, the application registers the event that it is interested in. An alternative approach is to post all the events to the application and let it process the events that the application is interested in. For example if a developer is using the existing Menu UI, the application will automatically receive motion events as a user moves the phone. The application can choose to ignore the events or act on the events based on the application behavior. This approach is beneficial when it is desirable for existing applications to become motion enabled without changing a all the software code. This information allows the motion interface to deliver appropriate events to the application as the camera moves. This technique is called the ‘device driver’ technique, since it is used analogously to a device driver.

Authoring Motion with Multimodality

V-Enable's previous patents refer to integrating data and voice as the mode of input and output. This application discloses integrating another mode—Motion—into the existing model. This allows the application developer to specify motion as another input mode. This section discusses the different ways in which an application developer can enable motion. A few simple ways are discussed here:

The user can decide to use motion as one of the modes of input using XML tags or through set of programming APIs.

If used with XML tags, the motion can be added as an attribute to any existing input tag of a markup language such as xHTML, WML, VoiceXML, cHTML, HTML etc.

The multimodality plays an interesting role here as the motion events can result in multimodal events or vice versa. For example while navigating the MAP, the motion events can result in Text To Speech action which prompts the user with the current location on the MAP. The developer can also program it to prompt the point of interest at a particular location. See, below. In summary the action on a Motion event can be used to start a multimodal dialog. An action on a multimodal dialog can initiate a motion action.

Using Existing Markup Languages:

The following WML visual source represents a way of navigating a menu on a mobile device. Note that while WML is used here as an example but the technique can also be applied on other markup languages such as xHTML, VoiceXML, X+V, SALT etc.

### EXAMPLE 1

### Menu Navigation

```
<?xml version=“1.0”?>
<!DOCTYPE wml PUBLIC “-//WAPFORUM//DTD WML 1.1//EN”
“http://www.wapforum.org/DTD/wml_1.1.xml”>
<wml>
    <head>
        <meta http-equiv=“Cache-Control” content=“must-
revalidate”/>
        <meta http-equiv=“Expires” content=“Tue, 01 Jan
1980 1:00:00 GMT”/>
        <meta http-equiv=“Cache-Control” content=“max-
age=0”/>
    </head>
    <card title=“MultiMode”>
    <p mode=“nowrap”>
        Following applications will demonstrate the power
        of V-Enable's MMGC. Select any of the following
        application and experience the difference. <br/>
        <b>Multimode Applications: </b><br/>
        <a href=“http://wap.cnet.com”>Cnet News</a>
        <a href=“http://www.bbc.co.uk/mobile/”>BBC
News</a>
        <a href=“http://wap.yahoo.com”>Yahoo Email</a>
        <a
href=“http://APP_SERVER/email.Script”>MultiMode Email</a>
    </p>
    </card>
</wml>
```

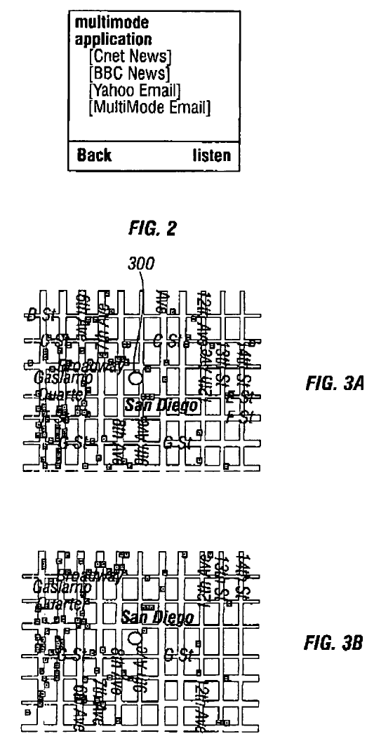

FIG. 2 shows an example of a user interface for a mobile browser based on the above WML visual source. The above page can be browsed using a combination of scroll keys and the select key.

The above page can be made motion-enabled by adding an extra “motion” attribute in the <p> tag. The value “true” indicates that the user wants to navigate using motion as well. The visual source now changes to

```
<?xml version=“1.0”?>
<!DOCTYPE wml PUBLIC “-//WAPFORUM//DTD WML 1.1//EN”
“http://www.wapforum.org/DTD/wml_1.1.xml”>
<wml>
    <head>
        <meta http-equiv=“Cache-Control” content=“must-
revalidate”/>
        <meta http-equiv=“Expires” content=“Tue, 01 Jan
1980 1:00:00 GMT”/>
        <meta http-equiv=“Cache-Control” content=“max-
age=0”/>
    </head>
    <card title=“MultiMode”>
    <p mode=“nowrap” motion=”true”>
        Following applications will demonstrate the power
        of V-Enable's MMGC. Select any of the following
        application and experience the difference. <br/>
        <b>Multimode Applications: </b><br/>
        <a href=“http://wap.cnet.com”>Cnet News</a>
        <a href=“http://www.bbc.co.uk/mobile/”>BBC
News</a>
        <a href=“http://wap.yahoo.com”>Yahoo Email</a>
        <a
href=“http://APP_SERVER/email.Script”>MultiMode Email</a>
    </p>
    </card>
</wml>
```

The V-Enable browser processes motion=“true” attribute and starts processing the live images. The user movement is then tracked and appropriate options are selected as user moves the mobile device.

### Example 2

### Image Navigation (e.g. Map)

The following WML source shows an example where an IMAGE can be scrolled using motion. The image scrolling can be used while viewing a map.

```
<?xml version=“1.0”?>
<!DOCTYPE wml PUBLIC “-//WAPFORUM//DTD WML 1.1//EN”
“http://www.wapforum.org/DTD/wml_1.1.xml”>
<wml>
    <head>
        <meta http-equiv=“Cache-Control” content=“must-
revalidate”/>
        <meta http-equiv=“Expires” content=“Tue, 01 Jan
1980 1:00:00 GMT”/>
        <meta http-equiv=“Cache-Control” content=“max-
age=0”/>
    </head>
    <card title=“MultiMode”>
    <p>
        This is a map
        <img src=http://veGATEWAY/images/map.jsp
    motion=”true”/>
    </p>
    </card>
    <catch>
        <if event=MOTION_LEFT>
            move image to left
            <prompt> There are museums at the vicinity
of this location </prompt
            <prompt> Would you like to hear more about
it? Say yes or no </prompt>
        <else if event = MOTION_RIGHT>
            move image to left
            <prompt> There is a AMC theatre near this
            location </prompt
            <prompt> Would you like to hear more about
            it? Say yes or no </prompt>
        <else if event = MOTION_UP>
            move image UP
        <else if event = MOTION_DOWN>
            move image down
        </if>
    </catch>
</wml>
```

The <img> tag of WML has an extra motion=“true” attribute which signals to the browser that motion should be enabled. Also the <catch> tag is a pseudo tag which is used to show how the map could be navigated using motion. The <prompt> tag uses the underlying speech engine and prompts the user with a speech output. The user can choose to respond the tag to listen more about the point of interest area in that region. If the user signals “yes”, then the user is presented with speech output describing the relevant point of interest around the selected area.

Once the image is displayed, the application handles the event that comes from the user actions resulted due to the motion. The events are MOTION_UP, MOTION_DOWN, MOTION_LEFT, MOTION_RIGHT etc as defined. Existing event model of the markup language can be used for delivering the events where the new events are added in the DTD of the markup language and the browser is modified to process the motion and generate motion events.

The above two examples are very basic examples where motion could be applied. Further details follow.

Using Programming Based APIs:

The V-Enable motion interface provides programming based APIs which allows a user to enable motion in their applications. The APIs provides the interface to the user and hides the complex details of motion. The API in turn uses the technology defined above and enables motion. These APIs use the motion event mechanism described above as the mode of communication with the application. The following is a list of few pseudo APIs which can be implemented on any platform. Note: the list is not limited these APIs and can be extended to any number of APIS.

MotionMENU: This API provides user an option to create a menu which uses motion to navigate. The API provides additional sub APIs which allows a application to add/remove menu items. The selection of a menu item is done using the event mechanism described above.

MotionImageViewer: This API provides user an option to display an image and navigate using motion. The selection of a point on the image (e.g. MAP) is done using the event mechanism described above.

Exemplary Description of a Motion Use Case with Multimodality

This section describes an embodiment which uses motion as one of the navigation modes. The embodiment also describes how speech modality and text modality are combined with the motion. The use case will be described in context of motion interface. The embodiment describes a Map Navigation example where the user navigates a map on a mobile screen using the motion mode.

The map navigation start with a multimodal interface where the user prompted to either speak or type the name of the city being looked for. Once the city is found, the user is prompted again to either speak or type the name of the street he is looking for. Once the MultiModal system (veGATEWAY) has identified the address the map for the address is fetched from the veGATEWAY and is displayed on the device display. The completion of map display also starts the Motion Interface which allows user to navigate the map using motion.

This demonstrates how a speech/text modality can initiate a motion interface.

In the map navigation, the user sees a map on the mobile with options to scroll to up/down/right/left or in diagonal direction. This accommodates the actual map dimensions being larger than the dimensions of the phone screen. In existing interfaces, this is achieved via a set of scroll keys. However there is typically no key to move the map in a direction other than right/left/up/down. In this use case we will show how a map can be navigated by moving the phone in any direction corresponding to where the user wants to see on the map. As the user is moving from one point to another point, the motion interface generates events to the application which allows application to act accordingly. The events can also be used to prompt the user with point of interest information as the user navigates through the map.

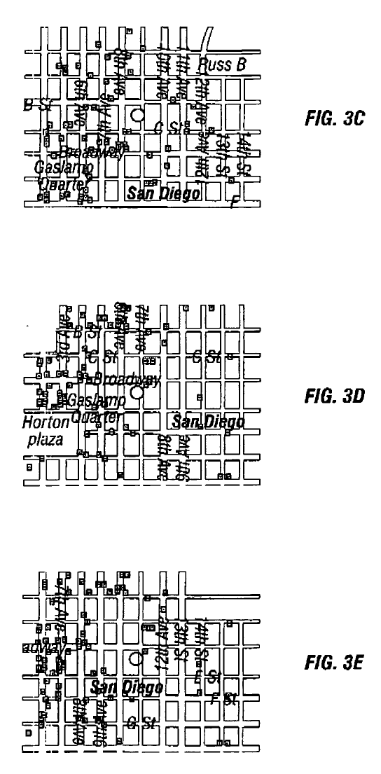

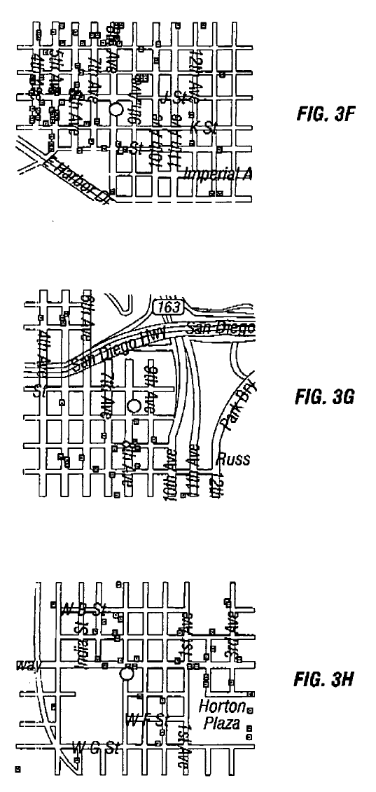

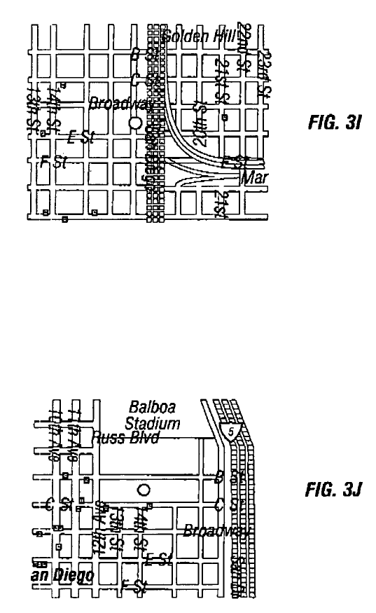

Assume that the user has entered the address using speech and client has requested the corresponding map for the address. FIG. 3A shows an image of the map that is displayed initially on the device using MotionImageViewer object.

The red circle represents the current point of reference with respect to motion.

The following is a list of events that the motion interface generates and the corresponding action taken by the application.

The application can be authored using XML based markup or using programming based APIs such as veCLIENT (our previous copending patent applications. In either case, similar motion events will be generated but the mechanism to handle the events would be different. In the case of XML based markup, the handling may be done using <catch> tags as described above. In programming based APIs, the handling will be done using the underlying event handling mechanism provided by the programming environment.

Note: The similar navigation can also be performed using the scroll key or other known techniques.

Note the location of the red circle 300 in FIG. 3A. Also along with every event, the application also receives the point of interest information in this example.

MOTION_DOWN
This event states that the user is moving the camera downwards. The event also sends the information on how many pixels (say x) user wants its map to move. The application upon receiving the event would scroll the map in the downward direction by x pixels to show the view in FIG. 3B.
The map has moved down. The point of interest information is ignored.

MOTION_UP
This event states that the user is moving the camera upwards. The event also sends the information on how many pixels (say x) user wants its map to move. The application upon receiving the event would move the map in the upward direction by x pixels as in FIG. 3C.
The map has moved up. The point of interest information is ignored.

MOTION_LEFT
This event states that the user is moving the camera in the left direction. The event also sends the information on how many pixels (say x) user wants its map to move. The application upon receiving the event would move the map in the left direction by x pixels as shown in FIG. 3D.
The map has moved left. Also since the Gas Lamp Quarter is very close to the RED circle the user is prompted this time using speech that Gas Lamp Quarter is nearby towards the west side. The user can be prompted with information by using the veCLIENT TextToSpeech API (see our copending patent application).

MOTION_RIGHT
This event states that the user is moving the camera in the right direction. The event also sends the information on how many pixels (say x) user wants its map to move. The application upon receiving the event would move the map in the right direction by x pixels as shown in FIG. 3E.
   The map has moved right.

For all above events the amount ‘x’ is configurable and user can define the value ‘x’ as per the application requirement. The default value may be provided by the Motion Interface but user is allowed to redefine the value as per the need. If the value ‘x’ is too low; it will generate too many events. This may cause problems since the mobile CPU may not be powerful enough to process so many events. In case the ‘x’ is too high it will cause the map to move at discrete points and the navigation would lose the continuous flow.

MOTION_DOWN_PAGE
This event states that the user has moved the camera in downward direction so much that the virtual displacement caused is more than the size of the vertical mobile screen. This causes the Motion Interface to generate the MOTION_DOWN_PAGE event. The application upon receiving the event would move the map in the downwards direction by a whole page. The whole page means the user wants to browse the map not pixel by pixel, but on a page basis. The size of the page depends on the display being used.
FIG. 3F shows the map moved down by one page. The user is prompted with following message “Map is scrolling down by one page”. veCLIENT TextToSpeech API is being used here.

MOTION_UP_PAGE
This event states that the user has moved the camera in the upward direction so much that the virtual displacement caused is more than the size of the vertical mobile screen. This causes the Motion Interface to generate the MOTION_UP_PAGE event. The application upon receiving the event would move the map in the upwards direction by a whole page as shown in FIG. 3G.
The map has moved up by one page. The user is prompted with following message “Map is scrolling up by one page”. veCLIENT TextToSpeech API is being used here.

MOTION_LEFT_PAGE
This event states that the user has moved the camera in left direction so much that the virtual displacement caused is more than the size of the horizontal mobile screen. This causes the Motion Interface to generate the MOTION_LEFT_PAGE event. The application upon receiving the event would move the map in left direction by a whole page.
FIG. 3H shows the map has moved left by one page. The user is prompted with following message “Map is scrolling left by one page”. veCLIENT TextToSpeech API is being used here.

MOTION_RIGHT_PAGE
This event states that the user has moved the camera in left direction so much that the virtual displacement caused is more than the size of the horizontal mobile screen. This causes the Motion Interface to generate the MOTION_LEFT_PAGE event. The application upon receiving the event would move the map in left direction by a whole page.
FIG. 3I shows the map has moved right by one page. The user is prompted with following message “Map is scrolling right by one page”. veCLIENT TextToSpeech API is being used here.

MOTION_ANY_DIRECTION
This event states that the user has moved the camera in direction which is neither left/right/up/down. This indicates that the user is not interested in any of the above movement. In such cases MOTION_ANY_DIRECTION event is generated. This event also provides information about the virtual displacement in terms of (x,y) coordinates. The application will receive this event every time a displacement (x,y) happens. The value of the (x, y) is configurable. The application on receiving this event moves the map in the direction of the movement (most of the time it is going to this event just because of the inaccuracies of image processing).
FIG. 3J shows the map has moved in the North East direction.

MOTION_SELECT
This event is generated if the user is stationary on an UI object or otherwise. The UI object could be an option in a list or it could be a point on a map. While navigating through the map, the user may stop at a point for a time period ‘t’. The MOTION_SELECT event is generated and the event passes the attributes of the point as well such as Latitude, Longitude, name etc.
This event indicates that the user has selected the current location and is interested in more information about the area. The application developer can decide to fetch the complete point of interest information and either display it or prompt it to the user. Or if application can compute directions to this point from the original point. The action entirely depends on the nature of the application.
   Detailed Description of Motion Implementation using the Camera Interface
   Assumptions:

1) The motion observed in 2 successive frames is small. Hence there is a large overlap in the image content of the 2 frames.

2) The maximum deviation that can be tracked meaningfully in a single frame is less than ⅔ of max dimensions of the image.

Resolution of raw frames: 160*120.

Resolution of images used in the algorithm: 40*30.

A sub sampled image is considered to reduce the computational requirement of the algorithm. This is not a bad assumption because most of the natural images have content which spans more than a 5 pixel width or height.

Images may be converted to rgb format before running the algorithm.

The intensity of pixels of the Image img at position (x,y) can be accessed as img[x][y]=(r+g+b)/3; where r, g, b are the red, blue and green components of the color of the pixel at position (x,y))

GetDeviation(Image refImg, Image currimg);
1) Max deviation is X, Y (min dev is −X, −Y); width and height of image is w, h
2) Assume the deviation in frame (compared to the reference frame) is devx, devy.
3) Calculate the sum of difference in pixels of the 2 frames. In the 2^{nd} frame the pixels considered are at an offset of devx, devy compared to the pixel in the first frame. The idea is that if this were the correct deviation then the sum thus calculated will be the least compared to any other combination of devx, devy
4) Calculate the minimum sum.

5) The devx, devy that leads to the minimum sum is the deviation the in 2^{nd} frame compared to the reference frame.

```
for(−X < devx < X)
{
for(−Y < devy < Y)
{
    index = xdev + ydev*X;
    sum[index] = 0;
    for(0 < x < w)
    {
        for(0 < y < h)
        {
            sum[index] += Abs(refImg[x][ y] −
    currImg[x+devx][y+devy]);
        }
    }
    if(sum[index] < min)
    {
        min = sum[index];
        observeredDevx = devx;
        observerDevy = devy;
    }
}
}
```

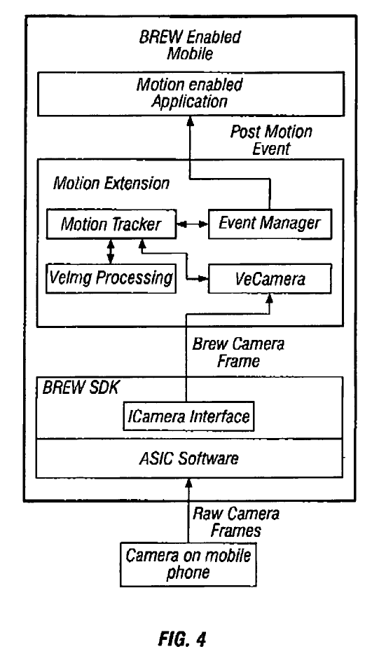

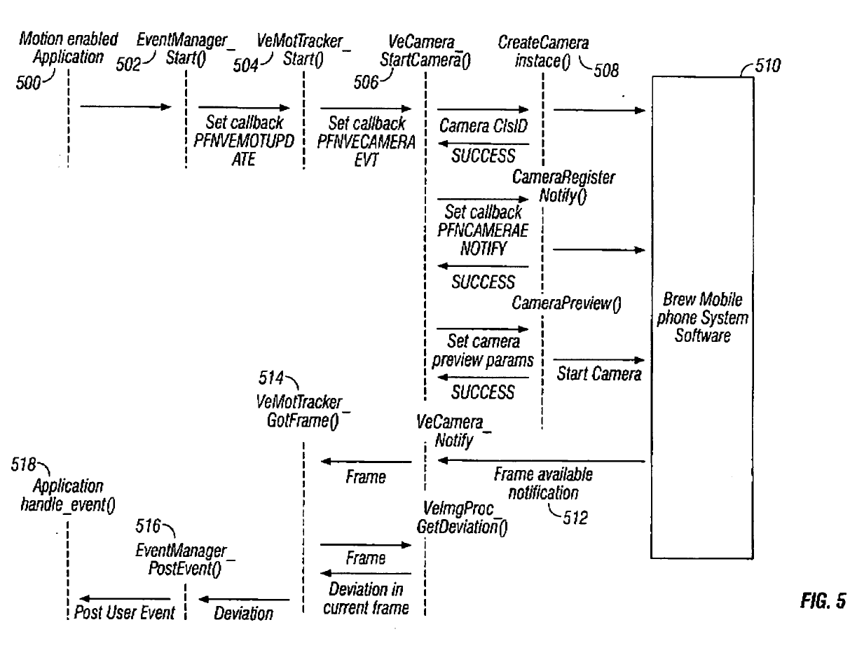

FIG. 4 describes the architecture of an application using motion. A BREW based device is used in this architecture. However the technique could be applied to any other programming environment such as J2ME, Symbian, Windows CE or any other mobile programming interface. This can be applied to other environments such as Phones Native Programming Environment, J2ME, and/or Windows.

The following is a list of interfaces developed to export the motion interface to the application. The interfaces were developed in a BREW programming environment, but of course could be applied to other mobile programming environments as listed above.

Public Interfaces:

EventManager: The public interface used by applications to produce motion related events. This interface receives raw motion updates (per frame) from the underlying interfaces. The event manager can be configured to produce events based on an application context or on pure observed motion (the current version does not have this feature). This uses 3 private interfaces: VeCamera, VeImgProcessing, VeMotTracker.

```
typedef struct {
    int state;
    VeMotTracker * veMotTracker;
    boolean stopEvents;
}VeEvtMgr;
int EventManager_CreateInstance(VeEvtMgr ** );
int EventManager_Start(VeEvtMgr *);
int EventManager_Stop(VeEvtMgr *);
void EventManager_ReleaseInstance(VeEvtMgr *);
```

Private Interfaces:

Camera: VeCamera is the interface used to get camera frames from the in-built camera on the phone. These frames are passed to the motion tracker interface for tracking motion.

```
typedef void (*PFNVECAMERAEVENT)(void * pUser, int result,
IBitmap * bmp);
typedef enum{
    IDLE,
    BUSY
}CameraStatus;
typedef struct{
    ICamera * m_pCamera;
    IBitmap * pFrame; // current frame
    CameraStatus pCamStatus;
    PFNVECAMERAEVENT cb;
    void * pUser;
}VeCamera;
int VeCamera_CreateInstance(VeCamera ** veCamera);
int VeCamera_StartCamera(VeCamera * pCamera,
PFNVECAMERAEVENT cb, void * pUser);
int VeCamera_StopCamera(VeCamera * pCamera);
int VeCamera_ReleaseInstance(VeCamera * pCamera);
ImageProcessing:
typedef int AlgoImage;
typedef enum
{
    REFERENCE_IMG,
    CURRENT_IMG
}ImgType;
typedef struct _pixel
{
    int x;
    int y;
    int red;
    int green;
    int blue;
}pixel;
typedef struct
{
    IBitmap * newBitmap;
    IBitmap * bitmap;
    AEEPoint veDeviation;
    boolean iHasBaseImage;
    boolean iInitialBaseImage;
    int iCallsToGetDev;
    AEEPoint iLastDev;
      boolean iHasLastImage;
    AlgoImage refImage[ALGO_IMG_X * ALGO_IMG_Y];
    AlgoImage currImage[ALGO_IMG_X * ALGO_IMG_Y];
    int refImageCnt;
    int currImageCnt;
}VeImgProcessing;
int VeImgProcessing_CreateInstance(VeImgProcessing ** );
void VeImgProcessing_ReleaseInstance(VeImgProcessing *);
int VeImgProcessing_GetDeviation(VeImgProcessing *, IBitmap
*);
void VeImgProcessing_Init(VeImgProcessing * veImgProc);
```

MotionTracker: VeMotTracker, on receiving the frames from the VeCamera interface sends them to be processed to the Image processing interface. Upon receiving the update from the image processing interface, the update is transferred to the event manager.

```
typedef void (*PFNVEMOTUPDATE) (void * pUser, int result,
AEEPoint posUpdate);
typedef struct
{
    VeCamera * veCamera;
    VeImgProcessing * veImgProc;
    PFNVEMOTUPDATE cb;
    void * pUser;
}VeMotTracker;
int VeMotTracker_CreateInstance(VeMotTracker **);
void VeMotTracker_ReleaseInstance(VeMotTracker *);
int VeMotTracker_StartTracking(VeMotTracker *,
PFNVEMOTUPDATE, void *);
int VeMotTracker_StopTracking(VeMotTracker *);
```

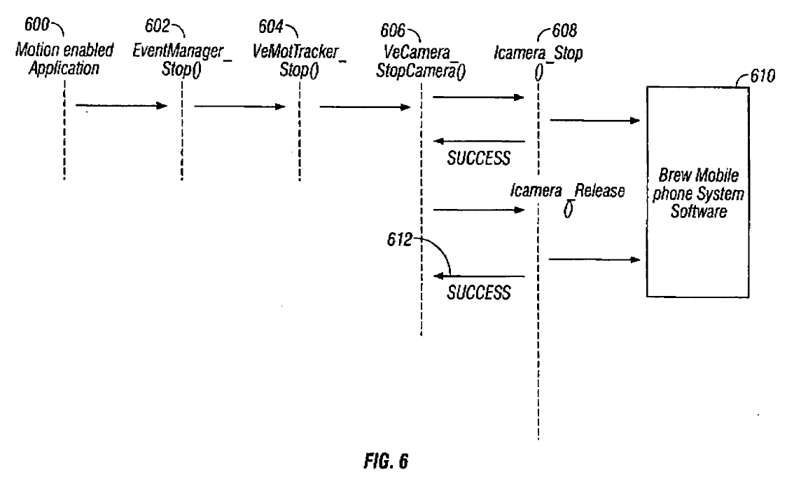

FIG. 5 illustrates the call Flow, and FIG. 6 illustrates the stopping event generation. Briefly, FIG. 5 shows how a motion enabled application is started at 500, starts the event manager at 502, and the motion tracker at 504. This assumes a camera at 506, and the camera instance is created at 508. A program running on the client 510 analyzes the camera output, and provides a return at 512 indicating that the frame is available. The frame is used at 514 to determine the motion, and the event manager at 516 produces the event which is coupled back to the application at 518.

The stopping application is analogous where the application at 600 determines a stop event at 602 which passes this to the motion tracker at 604, to the camera at 606, and produces a stop command at 608 to the software at 610. I success indication is returned at 612.

Although only a few embodiments have been disclosed in detail above, other embodiments are possible and the inventors intend these to be encompassed within this specification. The specification describes specific examples to accomplish a more general goal that may be accomplished in other way. This disclosure is intended to be exemplary, and the claims are intended to cover any modification or alternative which might be predictable to a person having ordinary skill in the art. For example, other operating systems can be used. The technique has been described as being usable in a mobile client, but it may be used in any other client, including PC, laptop, Palm, or any other client.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A method, comprising:
sensing motion of a mobile client; and
using the sensed motion as input to a program running on said mobile client to signal an input to the program, and to use said input to change some running aspect of the program.

2. A method as in claim 1, wherein said running aspect of the program is an area being displayed on the mobile client, where the sensed motion is used to change said area being displayed according to a direction of the sensed motion.

3. A method as in claim 1, further comprising using at least one of text and/or voice as additional inputs to the program.

4. A method as in claim 1, wherein said running aspect of the program includes selection from a list of options produced by the program, where the sensed motion is used to change the selection from the list according to a direction of the sensed motion and to execute the selection from the list as part of the running of the program.

5. A method as in claim 1, wherein said program is a game, and said running aspect of the program includes simulation of a movement of an input to the game.

6. A method as in claim 1, wherein said program displays a map, and said running aspect of the program uses said motion to change a displayed area of the map.

7. A method as in claim 1, wherein said using comprises scaling an amount of sensed motion by a scale factor other than one, as said input to said program.

8. A method as in claim 1, wherein said sensed motion is provided as an XML tag to the running program.

9. A method as in claim 8, wherein other tags to the running program are also provided, including at least a voice based tag.

10. A method as in claim 1, wherein said running program includes a browser, and said browser includes an XML tag indicating whether motion is enabled.

11. A method as in claim 1, wherein the motion is used to determine commands for the program including all of move left, move right, move up, move down, move page up, move page down, move page left, and move page right.

12. A method as in claim 1, where the motion is sensed by detecting an image produced by a camera, and sensing motion from changes in said image.

13. A system, comprising:
a portable client, including a processor and display; and
a motion sensing part, coupled to said processor and operating to sense motion and provide a signal based on said motion as an input to a program running on said portable client to signal an input to the program, and to use said input to change some running aspect of the program.

14. A system as in claim 13, wherein said portable client is a mobile telephone.

15. A system as in claim 13, wherein said running aspect of the program is an area being displayed, where the sensed motion is used to change said area being displayed according to a direction of the sensed motion.

16. A system as in claim 13, further comprising a user interface which allows entry of at least one of text and/or voice as additional inputs to the program.

17. A system as in claim 13, wherein said program includes a list of options, and said running aspect of the program includes selection from the list, where the sensed motion is used to change the selection from the list according to a direction of the sensed motion and to execute the selection from the list.

18. A system as in claim 13, wherein said program is a game, and said running aspect of the program includes simulation of a movement of an input to the game.

19. A system as in claim 13, wherein said program displays a map, and said running aspect of the program uses said motion to change a displayed area of the map.

20. A system as in claim 13, wherein said using comprises scaling an amount of sensed motion by a scale factor other than one, as said input to said program.

21. A system as in claim 13, wherein said sensed motion is provided as an XML tag to the running program.

22. A system as in claim 21, wherein other tags to the running program are also provided, including at least a voice based tag.

23. A system as in claim 13, wherein said running program includes a browser, and said browser includes an XML tag indicating whether motion is enabled.

24. A system as in claim 13, wherein the motion is used to determine commands for the program including all of move left, move right, move up, move down, move page up, move page down, move page left, and move page right.

25. A system as in claim 13, wherein said motion sensing part includes a camera.

26. A system as in claim 25, wherein said processor image processes an output of the camera to sense said motion.

27. A system as in claim 13, wherein said motion sensing part includes an accelerometer.

28. A method, comprising:
sensing motion of a client;
detecting input to a user interface of said client; and
using both the sensed motion and said input to the user interface as inputs to a program running on said client to signal an input to the program, and to use said input to change some running aspect of the program.

29. A method as in claim 28, wherein said running aspect of the program is an area being displayed on a display of said client, where the sensed motion is used to change said area being displayed according to a direction of the sensed motion.

30. A method as in claim 28, wherein said input to the user interface is alphanumeric key input.

31. A method as in claim 28, wherein said input to the user interface is voice input.

32. A method as in claim 31, wherein said sensing motion is done using a camera.

33. A method as in claim 28, further comprising converting an existing program to accept said motion as an input, using an explicit conversion, that allows the program to accept said motion directly as an input.

34. A method as in claim 28, further comprising using an implicit conversion to allow said program to accept said motion as an input, by converting said motion into a signal that will be accepted by the existing program to accept said motion as an input thereto.

35. A method as in claim 28, wherein said client is one of a mobile device, a laptop, a PC, or a PDA.
